(19) United States
(12) Patent Application Publication
(10) Pub. No.: US 2006/0046928 A1
(43) Pub. Date: Mar. 2, 2006

(54) Ziegler-natta catalyst and method for making and using same

(76) Inventors: Douglas D. Klendworth, West Chester, OH (US); Frank Wolf Spaether, Wachenheim (DE)

Correspondence Address: DILWORTH & BARRESE, LLP, 333 EARLE OVINGTON BLVD., UNIONDALE, NY, 11553, US

(21) Appl. No.: 10/925,618

(22) Filed: Aug. 25, 2004

(51) Int. Cl. B01J 31/00

(52) U.S. Cl. 502/103; 502/115; 502/116; 502/118

(57) ABSTRACT

A method for making magnesium-halide supports of a specified particle shape, average diameter and particle diameter distribution comprises providing a non-aqueous solution of a magnesium-halide containing silica particles dispersed therein, and crystallizing the magnesium-halide about the silica particles to provide the magnesium-halide support, wherein the magnesium-halide support has an approximately spherical shape, an average particle diameter from about 2 to about 120 microns, and a particle diameter distribution from about 1 to about 200, are provided. The invention further provides methods for making catalysts and using same in polymerization reactions. Catalyst supports and catalysts are also provided.

### FIELD OF THE INVENTION

The present invention relates to catalysts, and particularly to Ziegler-Natta catalysts and to a method for making and using catalysts in polymerization reactions.

### BACKGROUND OF THE INVENTION

Ziegler-Natta catalysts are advantageously used in olefin polymerization reactions to produce stereoregulated linear polymers. It is known that Ziegler-Natta catalysts may be formed by coating a silica support material with a magnesium-halide compound, a transition metal compound, electron donor compound(s) and an organo-aluminum cocatalyst. The transition metal is an active catalytic ingredient and the magnesium-halide compound may also be thought of as being active to the extent that it acts as a synergist to increase the overall catalytic productivity of the transition metal. The electron donor compounds and organo-aluminum cocatalyst are important because they enable the Ziegler-Natta catalyst to catalyze polymerization of isotactic polymers. The silica material is inactive and does not increase polymerization reaction rates.

It is known that silica-based Ziegler-Natta catalysts may be produced from high-porosity silica particles in the diameter range of about 10-100 microns, which may be coated with 1 or more relatively thin layers of a magnesium-halide compound to form a catalyst support, which may be treated with a transition metal to form a catalyst. However, this type of catalyst generally comprises a high ratio of inactive silica relative to the active ingredients. Further, the catalyst supports may need to be mechanically treated to produce generally spherical, or spheroidal, catalyst supports of the appropriate diameter and particle diameter distribution, which will form catalyst particles of the appropriate diameter and particle diameter distribution and, thus, will facilitate efficient polymerization reactions.

U.S. Pat. Nos. 4,293,673 and 4,376,062, both to Hamer et al., disclose methods for forming silica based catalysts with very small silica particles, no larger than about 0.05 micron, which are mixed in a slurry to form solid agglomerations comprising a number of silica particles mixed with active ingredients. While Hamer utilizes silica particles which are very small, the resulting catalysts still comprise at least 10 wt % inert silica material. This is undesirable because the higher the relative amount of inert silica material the lower the overall activity of the catalyst, and the higher the amount of catalyst residues in a polymer formed therewith. Thus, the production costs of the polymer, per weight unit of catalyst, is higher for catalysts containing relatively large amounts of inert material. Further, higher amounts of catalyst residues may detrimentally affect polymer processing and/or the physical properties of products made with the polymer.

Thus, there is a need for an efficient and reliable method for producing catalyst support materials, and ultimately catalysts, which comprise a relatively small percentage of inactive materials, and which have a relatively smooth spherical or spheroidal shape and suitable average particle diameter and particle diameter distribution.

### SUMMARY OF THE INVENTION

The invention comprises a method for making magnesium-halide supports of a specified particle shape, average diameter and particle diameter distribution, which comprises providing a non-aqueous solution of a magnesium-halide containing silica particles dispersed therein, and crystallizing the magnesium-halide about the silica particles to provide the magnesium-halide support, wherein the support has an approximately spherical shape, an average particle diameter from about 10 to about 120 microns, and a particle diameter distribution from about 10 to about 150 microns The invention further comprises methods for making catalysts and using same in polymerization reactions. The invention further comprises catalyst supports and catalysts.

Catalysts of the invention may include transition metal compounds, organo-aluminum co-catalysts and/or electron donors and may be useful for the polymerization of olefins to provide polymers having good morphology and bulk density.

### BRIEF DESCRIPTION OF THE DRAWINGS

FIG. 1 is a photomicrograph of particles of 100% MgCl₂ at 50× magnification;

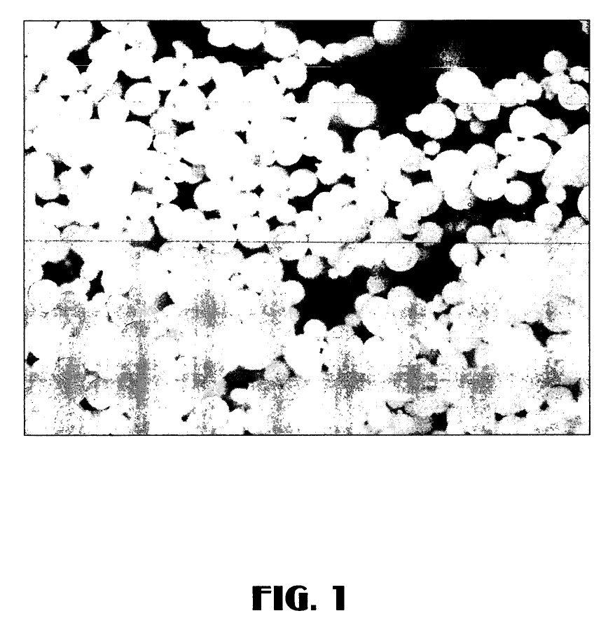

FIG. 2 is a photomicrograph of particles of 90% MgCl₂ and 10% CAB-O-SIL® silica at 50× magnification; and

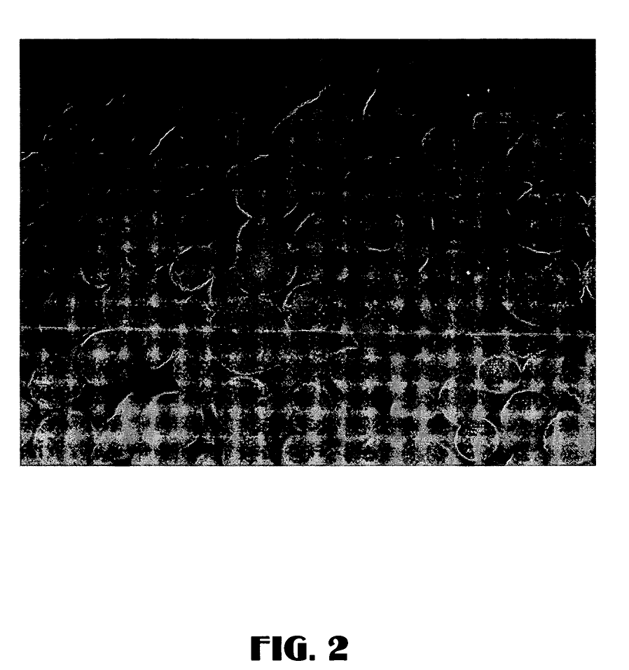

FIG. 3 is a photomicrograph of particles of 98% MgCl₂ and 2% CAB-O-SILO silica at 50× magnification.

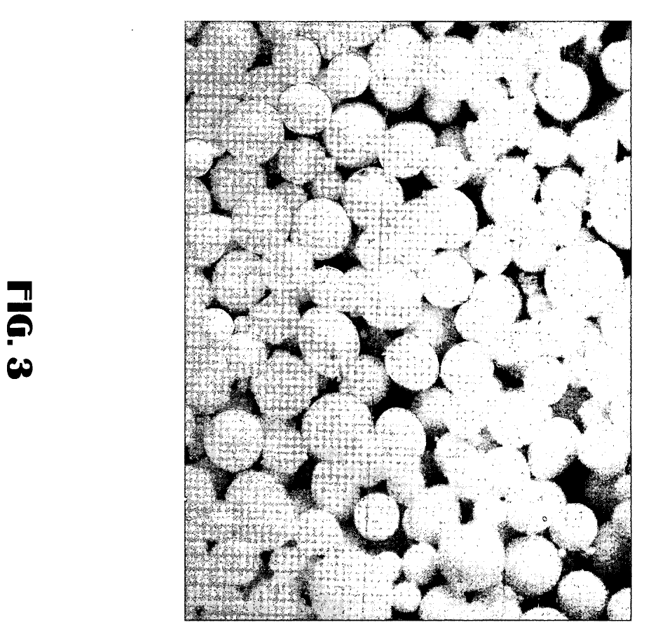

### DETAILED DESCRIPTION OF PREFERRED EMBODIMENTS

The present invention generally concerns Ziegler-Natta catalysts and processes for making and using same, which may include coating a silica support material, acting as a seeding agent, with a magnesium compound to form a solid catalyst support. The catalyst support may be reacted with a transition metal, an internal electron donor, an organo-aluminum co-catalyst and an external electron donor to form a catalyst suitable for, for example, various polymerization reactions.

In a preferred process, a silica seeding agent is dispersed in a non-polar, non-ionic oil, for example, mineral oil, paraffin oil or silicone oil, in a mixing apparatus such as a simple paddle stirrer operating at a few hundred rpms or a Ultra-Turrax® T 50 Homogenizer with stirring speeds up to 10,000 rpms. Preferably, the ratio of silica seeding agent to oil is in the range of about 0.25 grams per liter to about 25.0 grams per liter, more preferably about 1.0 gram per liter to about 10.0 grams per liter. The silica seeding agent is described in more detail below.

Anhydrous magnesium halide compound can be added to the dispersion of silica in oil, followed by addition of an alkanol solvent such as anhydrous ethanol, methanol, or 2-ethyl-1-hexanol. Alternatively, anhydrous ethanol, methanol or 2-ethyl-1-hexanol can be added to an anhydrous (i.e., less than about 0.5 wt % H₂O) magnesium-halide compound to form a soluble complex, as described below. About 0.01 wt % to about 10.0 wt %, more preferably from about 0.1 wt % to about 5.0 wt %, and still more preferably from about 0.5 wt % to about 3.0 wt % of the silica seeding agent is used relative to the magnesium-halide compound. Generally, a higher ratio of magnesium-halide to silica seeding agent in the mixture results in a higher ratio of magnesium-halide to silica in the catalyst support formed and, consequently, a larger catalyst support is expected to form because more magnesium-halide crystalizes onto the silica seeding agent.

The solvent is added in amounts from about 2 to 20 times, preferably about 6 times, the molar ratio of the magnesium-halide compound to facilitate the liquefying of the magnesium-halide compound at a lower temperature. U.S. Pat. No. 4,421,674 to Invernizzi et al. teaches, for example, that when the mole ratio of ethanol (“EtOH”) to MgCl₂ is 10.2, the complex liquefies at 60° C.; at a mole ratio of EtOH to MgCl₂ of 7.75 the complex liquefies at 80° C.; at a mole ratio of EtOH to MgCl₂ of 6.51 the complex liquefies at 90° C.; and at a mole ratio of EtOH to MgCl₂ of 5.43 the complex liquefies at 100° C. The mixture is initially translucent due to the suspension of the magnesium-halide compound and the silica seeding agent. The mixture is heated to about 60° C. to about 140° C., preferably about 80° C. to about 120° C., until the solvent begins to reflux and the magnesium-halide compound goes into solution, whereupon the mixture becomes transparent, and the temperature is maintained at the reflux temperature for about 0.25 hours to about 3.0 hours, preferably about 1.0 hour to about 2.0 hours, preferably with continuous stirring. It is possible to form the mixture without either the oil or the solvent, or by mixing the ingredients in a different order, but the above-described mixing operation has been shown to result in a well-dispersed mixture.

The clear mixture, which includes a MgCl₂.xEtOH complex (where x is an integer from 1-20), is rapidly transferred to a second mixing apparatus containing a pre-chilled hydrocarbon solvent, such as heptane, hexane, cyclohexane, or other aliphatic or cycloaliphatic hydrocarbon which is miscible in the oil and which will not freeze at the temperatures necessary for the solidification of the MgCl₂.xEtOH complex. The hydrocarbon solvent is pre-chilled, for example, to between ice (0° C.) and dry ice/isopropanol temperatures (i.e., about −70° C. to −90° C.). The rapid temperature decrease causes almost all of the magnesium-halide compound to precipitate out of solution and crystallize onto the silica seeding agent, thus coating the silica seeding agent to form a catalyst support. The catalyst support particles preferably include less than 10 wt % silica, preferably no more than 5 wt % silica, and more preferably no more than 3 wt % silica.

After about 0.5 to 2 hours, preferably about 1 hour, the mixture is allowed to warm to room temperature and it is filtered. Approximately spherical and/or spheroidal solid catalyst support particles, each comprising at least one silica seeding agent with magnesium-halide crystals attached thereto, are collected and washed several times with more hydrocarbon solvent, until the hydrocarbon solvent appears to be colorless, and are dried (e.g., vacuum dried) in a rotary evaporator at about 40° C. to 80° C., preferably at about 60° C., for 1 to 3 hours, preferably for about 2 hours. The term “approximately spherical” or “approximately spheroidal” means that all points on the surface of the particle are within the range of radius r to 2r wherein r is the minimum radial distance between the center of the particle and the closest point thereto on the surface of the particle. The magnesium-halide compound may alternately be crystallized onto the silica seeding agent with known spray drying techniques or by gradually evaporating the solvent in which it was originally dissolved.

Next, the catalyst support is slowly added to about 10 to 50 moles of a transition metal compound for each mole of magnesium in the magnesium-halide compound at about −30 to 50° C., and the temperature of this mixture is raised to about 20 to 80° C., preferably about 30-60° C. An internal electron donor is added and the temperature is raised, generally with stirring, to about 80 to 130° C., preferably 100-110° C., and is kept at that level for about 1 to 3 hours, preferably about 2 hours.

The internal electron donor compound, in general, is used in an amount from about 0.05 to about 2.0 moles, preferably about 0.1 to about 0.5 mole, for each mole of magnesium in the magnesium-halide compound.

The result is a mixture comprising solid catalyst particles and unreacted transition metal compound and internal electron donor compound.

The solid catalyst particles are filtered out and, preferably, extracted for about 1 to 3 hours, preferably about 2 hours, at about 110 to 140° C., more preferably about 125° C. with a mixture of transition metal compound (about 5 to 30 wt %, preferably about 10 wt %), and an inert solvent, such as a C₁-C₁₀ alkylbenzene, preferably ethylbenzene (about 70 to 85 wt %, preferably about 90 wt %) in a known “Soxhlet” extraction type arrangement. This extraction treatment enhances catalyst activity and stereospecificity. Alternatively, the solid catalyst may receive any number of other known extraction treatments, which may, but need not, include a transition metal treatment. Alternatively, the catalyst could simply be boiled in a solution comprising a transition metal compound with or without an inert solvent, i.e., a solvent which will not react with the transition metal compound. U.S. Pat. No. 4,745,164 to Schweier et al. and U.S. Pat. No. 6,034,023 to Kersting et al., which are incorporated by reference herein, teach examples of extraction methods which may be utilized in the present invention.

The solid catalyst may be recovered by filtration, washed with an inert solvent, such as heptane, hexane, cyclohexane or other aliphatic or cycloaliphatic hydrocarbon, dried by draining off transition metal compound and solvent, washed a second time with the inert solvent, and dried.

The solid catalyst support particles and/or catalyst particles preferably comprise about 0.01 wt % to about 10 wt % silica, more preferably about 0.1 wt % to about 5 wt % silica.

The solid catalyst support particles and/or catalyst particles preferably have a weight percent ratio of silica to magnesium-halide compound in the range of about 1:20 to 1:3, preferably from about 1:10 to 1:4.

The catalyst may preferably be treated with an organo-aluminum co-catalyst and an external electron donor or other stereoregulating agent to form a Ziegler-Natta catalyst, which may be used, for example, in polymerization reactions. Examples of external electron donor compounds which may be used in the catalytic system of the invention include mono- and polyfunctional carboxylic acids, carboxylic anhydrides and carboxylic esters, and ketones, ethers, alcohols, lactones as well as organic phosphorus and silicon compounds. Also, a mixture of two or more external electron donor compounds can be used. The external electron donor compound and the internal electron donor compound used in the preparation of the solid catalyst component may be the same or different. Preferred external electron donor compounds are disclosed below.

In such cases the organo-aluminum co-catalyst and the external electron donor may be contacted with the solid catalyst separately, in any order, or together, preferably at a temperature from about 0 to 200° C., more preferably from about 20 to 90° C., and preferably at a pressure of about 1 to 100 bar, more preferably from about 1 to 40 bar.

Preferably, the organo-aluminum co-catalyst is added in such an amount that the molar ratio of the aluminum co-catalyst to the transition metal in the solid catalyst is from about 10:1 to about 800:1, more preferably from about 20:1 to about 200:1.

The external electron donor is used with the catalyst in amounts ranging from about 1 to 100 moles, preferably 10 to 30 moles, for each mole of transition metal in the catalyst. Generally, it is highly preferred that an external electron donor, with or without the organo-aluminum co-catalyst, be used in order to maintain a high level of stereospecificity in polymers produced with the catalysts of the invention.

A preferred silica seeding agent is a microspheroidal silica (SiO₂), for example, a fumed silica such as CAB-O-SIL®-5 (Cabot Corporation; Midland, Mich.). Other silica seeding agents may include, for example, Aerosil® fumed silica, available from USA Midwest Degussa Corporation, 3500 Embassy Parkway Ste. 100, Akron Ohio 44333.

The silica seeding agent is characterized by its relatively small average particle diameter, i.e., preferably about 0.005-10 microns, more preferably about 0.001-5.0 microns, most preferably from about 0.01 microns to about 1.0 micron. The silica seeding agent has low porosity because of its lack of, or small quantity of, pores. That is, it has a porosity of less than about 0.5 cc/gram as measured by nitrogen adsorption, which indicates that the silica particles have relatively smooth surfaces. The silica seeding agent particles have relatively uniform spherical or spheroidal shape, i.e., approximately spherical shape, and preferably having a radius which does not vary by more than about 20% from the center to any point on the surface of the particle. The particles of the silica seeding agent have a relatively small particle diameter distribution, such that 50% of the silica particles have particle diameters ranging from about 0.05 microns to about 0.5 microns.

The small particle diameter of the silica seeding agent is significant because the resulting catalyst will ultimately comprise a relatively small percentage, i.e., less than 10 wt %, of inert silica material as compared to the total weight of the catalyst support. Thus, the catalyst will operate more efficiently because a relatively larger portion of the solid catalyst will comprise active catalytic material, i.e., the transition metal and the magnesium-halide synergist. In preferred catalyst supports the silica component will be less than 10 wt % of the total catalyst support weight, more preferably about 0.1 wt % to about 5 wt %, and yet more preferably about 0.5 wt % to about 3.0 wt % of the catalyst support formed by the above-described processes. Since the silica seeding agent provides a surface upon which the magnesium-halide compound will crystallize, the smooth approximately spherical shape and small particle diameter distribution of the silica seeding agent will result in catalyst support particles, and ultimately catalyst particles, with a relatively smooth approximately spherical shape and small particle diameter distribution. These qualities will contribute to an efficient polymerization process with a relatively small amount of fines in polymers produced in reactions conducted with the catalysts of the invention. This is an advantage over other catalysts which, for example, may need to undergo various complex and expensive processes in order to acquire an approximately spherical shape and/or acceptable particle diameter and particle diameter distribution.

The diameters of the catalyst support particles will range from about 5-150 microns, more preferably from about 20-60 microns, most preferably from about 20-40 microns. The particle size distribution of the catalyst support particles is such that 50% of the catalyst support particles have particle diameters ranging from about 20 microns to about 60 microns.

The catalyst particles will have diameters which are about 20%-50% smaller. For example, a support particle with a 70 micron diameter may result in a catalyst particle with a 50-60 micron diameter. The reason for this reduction in size is as follows. It is generally known that ethanol dissolves the MgCl₂ by first swelling the structure of the solid MgCl₂. (MgCl2 has a layered structure. Ethanol occupies the interstitial spaces between the MgCl₂ layers.) As more alcohol is added and/or the material is heated, this structure continues to swell or expand until the MgCl₂ layers segregate and the MgCl₂oEtOH complex becomes a liquid. When this complex is reacted with TiCl₄, the removal of ethanol causes the structure and thus the particle to shrink or diminish in size. Thus, the catalyst supports and catalysts of the invention are notable for having relatively thick layers of active ingredients, referring to both the synergistic magnesium-halide layer and active transition metal layer, on relatively small silica particles. Again, this results in the overall percentage of inactive silica delivered to a polymerization reactor to be lower than in other known processes. Consequently, overall efficiency in the polymerization reactor will be higher.

Preferably, catalyst support particles and catalyst particles of the invention will each include one silica seed particle, or a small group of silica seed particles comprising less than 10% of the total catalyst support weight. In contrast to the present invention, other known catalysts typically comprise relatively large silica particles or agglomerations of a number of very small silica particles within each catalyst support particle such that there is a relatively larger amount (e.g., up to 50 wt %) of inert silica in the catalyst particle.

The magnesium compound is an inorganic solid magnesium-halide compound containing at least one halogen atom, such as magnesium chloride, magnesium bromide and magnesium iodide, as well as mixed halogen oxides or hydroxides like chloromagnesium hydroxide, bromomagnesium hydroxide and iodomagnesium hydroxide. Among these compounds the magnesium dihalides corresponding to the formula MgX₂ are preferred wherein X is a halogen. Especially preferred is magnesium chloride (MgCl₂). Preferably, the inorganic solid magnesium-halide compound is in a substantially anhydrous condition.

Transition metal compounds for treating the catalyst support are preferably titanium or vanadium compounds. Titanium compounds useful in preparing the solid catalyst component include the halogenides of tri- or tetravalent titanium. Titanium alkoxy halogenide compounds and mixtures of two or more titanium compounds are also contemplated. Examples of suitable titanium compounds include TiBr₃, TiBr₄, TiCl₃, TiCl₄, Ti(OCH₃)Cl₃, Ti(OC₂H₅)Cl₃, Ti(O-iso-C₃H₇)Cl₃, Ti(O-n-C₄Hg)Cl₃, Ti(OC₂H₅)Br₃, Ti(O-n-C₄H₉)Br₃, Ti(OCH₃)₂Cl₂, Ti(OC₂H₅)₂Cl₂, Ti(O-n-C₄H₉)₂Cl₂, Ti(OC₂H₅)₂Br₂, Ti(OCH₃)₃Cl, Ti(OC₂H₅)₃Cl, Ti(O-n-C₄H₉)₃Cl, Ti(OC₂H₅)₃Br, Ti(OCH₃)₄, Ti(OC₂H₅)₄, or Ti(O-n-C₄H₉)₄. Preferred titanium compounds include those wherein the halogen is chlorine. Also preferred are those titanium halogenides that in addition to the titanium contain only halogen, and of these the titanium chlorides, and in particular titanium tetrachloride, are preferred.

Vanadium compounds useful in the preparation of the solid catalytic component of the catalytic system described herein include the vanadium halogenides, the vanadium oxyhalogenides, the vanadium alkoxides and vanadium acetylacetonate. Preferred vanadium compounds are those having oxidation stages 3 to 5.

The function of the internal and external electron donors, e.g., Lewis bases, is two-fold. One function is to block “coordinately unsaturated” sites on the magnesium compound so that the active site, the transition metal compound, will not attach to those sites. The other function is to reduce the “coordinately unsaturated” environment around the bound active site in order to improve its stereospecificity. Both results are the same, i.e. the electron donors improve the isotacticity or stereoregularity of polymers produced with the catalyst. The reason for this is that a “coordinately unsaturated” site has a lower energy barrier for binding propylene in various configurations, i.e., it can bond to propylene in multiple ways, leading to a reduction in polymer isotacticity and subsequently lower polymer crystallinity. Lower polymer crystallinity results in lower polymer melting points and increased hydrocarbon (e.g., xylene, decalin, or heptane) solubles. A “coordinatively saturated” site will predominately bond to the active site in only one way. As a result, a coordinatively saturated site produces uniform or isotactic polypropylene.

Internal electron donor compounds which may be used in the preparation of the solid catalytic component include, at least, mono or polyfunctional carboxylic acids, carboxylic anhydrides, or carboxylic esters, and also ketones, ethers, alcohols, lactones or organophosphorous or organosilicon compounds.

Preferred internal electron donor compounds included carboxylic acid derivatives and, in particular, phthalic acid derivatives having the general formula (I): 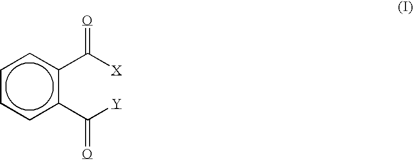
wherein X and Y each represent a chlorine or bromine atom or a C₁-C₁₀ alkoxy group, or X and Y taken together represent an oxygen atom forming an anhydride function. Particularly preferred internal electron donor compounds are phthalic esters of formula (I) wherein X and Y each are a C₁-C₈ alkoxy group, such as a methoxy, ethoxy, n-propyloxy, isopropyloxy, n-butyloxy, sec-butyloxy, or tert-butyloxy group. Examples of preferred phthalic esters include diethyl phthalate, di-n-butyl phthalate, di-isobutyl phthalate, di-n-pentyl phthalate, di-n-hexyl phthalate, di-n-heptyl phthalate, di-n-octyl phthalate or di-2-ethylhexyl phthalate.

Further examples of preferred internal electron donor compounds include diesters of 3- or 4-membered, optionally substituted cycloalkane 1,2-dicarboxylic acids, as well as monoesters of substituted benzophenone 2-carboxylic acids or substituted benzophenone 3-carboxylic acids. As hydroxy compounds in the esterfication reaction for synthesis of these esters, alkanols such as C₁-C₁₅ or C₅-C₇ cycloalkanols (optionally substituted with one or more C₁-C₈ alkyl groups), as well as C₁-C₁₀ phenols, can be used. A particularly preferred internal electron donor is di-alkyl carboxylic acid ester.

A further group of suitable internal electron donor compounds are the non-substituted and substituted (C₁-C₁₀ alkyl)-1,3-propane diethers and derivatives of the group of succinates.

Also, mixtures of two or more internal electron donor compounds may be used in the preparation of the solid catalytic component of the invention.

Examples of external electron donor compounds which may be used in the catalytic system of the invention include mono- and polyfunctional carboxylic acids, carboxylic anhydrides and carboxylic esters, and ketones, ethers, alcohols, lactones as well as organic phosphorus and silicon compounds. Also, a mixture of two or more external electron donor compounds can be used. The external electron donor compound and the internal electron donor compound used in the preparation of the solid catalyst component may be the same or different. However, it is generally preferred that the internal and external electron donors be different because the desired internal electron donor is one which will block sites that lead to “coordinative unsaturation” or that transform “coordinatively unsaturated” sites into “coordinatively saturated” sites. And yet these internal electron donors do not react with TiCl₄. In the case of external electron donors, the desired molecule is one that will have the same affect on “coordinative saturation”, but will not react with the aluminum alkyl cocatalyst. A molecule that yields “coordinative unsaturation” yet does not react with either TiCl₄ and AlR₃ would be ideal. However, due to the difficulty in finding such a single substance, most polypropylene catalysts employ two separate substances for their internal and external electron donors.

Preferred external electron donor compounds include the organosilicon compounds of the general formula (II):
R¹ₙSi(OR²)₄₋ₙ (II)

wherein each R¹ may be the same or different and represents a C₁-C₂₀alkyl group, a 5- to 7-membered cyclic alkyl group optionally substituted with C₁-C₁₀ alkyl, a C₆-C₁₈ aryl group or a C₆-C₁₈ aryl-C₁-C₁₀ alkyl group; and each R² may be the same or different and represents a C₁-C₂₀alkyl group; and n is an integer equal to 1, 2 or 3.

Preferred compounds of formula (II) are diisopropyldimethoxysilane, isobutylisopropyl-dimethoxysilane, diisobutyldimethoxysilane, dicyclopentyl-dimethoxysilane, cyclohexylmethyldimethoxysilane, dicyclohexyldimethoxysilane, isopropyl-tert-butyldimethoxysilane, isopropyl-sec-butyldimethoxysilane, and isobutyl-sec-butyldimethoxysilane.

Other stereoregulating agents which may be substituted for the external electron donor include alcohols, phenols, ketones, aldehydes, carboxylic acids, organic or inorganic acid esters, ethers, acid amides and acid anhydrides, and nitrogen-containing electron donors such as ammonia, amines,

nitriles and isocyanates. Specific examples include alcohols having 1 to 18 carbon atoms which may have an alkyl group such as methanol, ethanol, propanol, pentanol, hexanol, octanol, 2-ethylhexanol, dodecanol, octadecyl alcohol, benzyl alcohol, phenylethyl alcohol, cumyl alcohol and isopropylbenzyl alcohol; phenols having 6 to 25 carbon atoms such as phenol, cresol, xylenol, ethylphenol, propylphenol, cumylphenol, nonylphenol and naphthol; ketones having 3 to 15 carbon atoms such as acetone, methyl ethyl ketone, methyl isobutyl ketone, acetophenone and benzophenone; aldehydes having 2 to 15 carbon atoms such as acetaldehyde, propionaldehyde, octylaldehyde, benzaldehyde, tolualdehyde and naphthaldehyde; organic acid esters having 2 to 30 carbon atoms such as methyl formate, ethyl acetate, vinyl acetate, propyl acetate, octyl acetate, cyclohexyl acetate, ethyl propionate, methyl butyrate, ethyl valerate, ethyl stearate, methyl chloroacetate, ethyl dichloroacetate, methyl methacrylate, ethyl crotonate, dibutyl maleate, diethyl butylmalonate, diethyl dibutylmalonate, ethyl cyclohexanecarboxylate, diethyl 1,2-cyclohexane-dicarboxylate, di-2-ethylhexyl 1,2-cyclohexanedicarboxylate, methyl benzoate, ethyl benzoate, propyl benzoate, butyl benzoate, octyl benzoate, cyclohexyl benzoate, phenyl benzoate, benzyl benzoate, methyl toluate, ethyl toluate, amyl toluate, ethyl ethylbenzoate, methyl anisate, ethyl anisate, ethyl ethoxybenzoate, dimethyl phthalate, diethyl phthalate, dibutyl phthalate, dioctyl phthalate, gamma-butyrolactone, delta-valerolactone, coumarin, phthalide and ethylene carbonate; inorganic acid esters such as ethyl silicate, butyl silicate, vinyltriethoxysilane, phenyltriethoxysilane and diphenyldiethoxysilane; acid halides having 2 to 15 carbon atoms such as acetyl chloride, benzoyl chloride, tolyl chloride, anisoyl chloride and phthaloyl dichloride; ethers having 2 to 20 carbon atoms such as methyl ether, ethyl ether, isopropyl ether, butyl ether, amyl ether, tetrahydrofuran, anisole and diphenyl ether; acid amides such as acetamide, benzamide and toluamide; acid anhydrides such as benzoic anhydride and phthalic anhydride, amines such as methylamine, ethylamine, diethylamine, tributylamine, piperidine, tribenzylamine, aniline, pyridine, picoline and tetramethylethylenediamine; and nitriles such as acetonitrile, benzonitrile and tolunitrile.

Polymerization is initiated by formation of a metal-carbon bond (Ti—C). The function of the aluminum alkyl is to alkylate the TiCl₄. This can be accomplished in a variety of ways: by addition of aluminum alkyl to the reactor separate from the catalyst, by premixing the aluminum alkyl with the catalyst prior to addition to the reactor, or by premixing of the aluminum alkyl and external electron donor prior to mixing with the catalyst.

Examples of suitable organo-aluminum co-catalysts include aluminum trialkyls (AlR₃) and derivatives thereof wherein an alkyl group is substituted by an alkoxy group or a halogen atom, e.g. chlorine or bromine atom. The alkyl groups may be the same or different. The alkyl groups may be linear or branched chain alkyl groups. Preferred trialkylaluminum compounds are those wherein the alkyl groups each have 1 to 8 C-atoms, such as trimethylaluminum, triethylaluminum, tri-isobutylaluminum, trioctylaluminum or methyldiethyl aluminum.

The equipment used in the processes of the invention are well known in the art and, generally, may be substituted for by those familiar with catalysts and their production. Reactor systems can include high pressure, stainless steel vessels, low pressure, glass vessels, CSTR vessels, loop reactors, vertical stirred-bed gas phase reactors, horizontal stirred-bed gas phase reactors, vertical, fluid-bed gas phase reactors, and the like.

The catalysts of the present invention were tested for polymerization performance using a 2-liter, jacketed, stainless steel reactor available from Pressure Products Industries, Inc., 900 Louis Drive, Warminster, Pa. 18974. Liquid propylene was metered in using a high pressure site-glass. Hydrogen was added by measuring the pressure differential across a 300 ml vessel.

A test sample of a preferred catalyst of the invention was prepared and tested as follows:

### Catalyst Preparation Procedure

50 milligrams of CAB-O-SIL® was dispersed in about 250 ml of mineral oil in a flask by stirring. Subsequently, 10 grams of anhydrous MgCl₂, followed by 6 equivalents of anhydrous ethanol (per equivalent of magnesium) was added. The mixture was heated until the ethanol began to reflux. The mixture was maintained at this temperature for about 1 hour with continuous stirring.

The contents of the flask were then rapidly transferred to a second flask containing 1 liter of heptane pre-chilled to dry ice/isopropanol temperatures. After an hour the temperature of the contents of the second flask were allowed to warm to room temperature and were then filtered. Approximately spherical solid catalyst support particles were collected and washed several times with heptane, until the washings appeared to be colorless, and then vacuum dried in a rotary evaporator at 60° C. for about 2 hours.

Next, the solid catalyst support particles were added slowly to a third flask containing 200 ml of neat TiCl₄, which had been pre-cooled to about 0° C. After the temperature was raised to about 50-60° C., 1.5 ml of di-n-butylphthalate, a di-alkylcarboxylic acid ester, as an internal electron donor, was added. The contents of the third flask were heated to 100-110° C. and held at that temperature for about 2 hours.

The heat was removed, and solid catalyst particles and liquid from the third flask were transferred to a Soxlet extractor. The liquid, which comprised unreacted TiCl₄ and internal electron donor compound, was removed by filtering through a porous sintered glass filter that is part of the reaction vessel. The remaining solid catalyst particles were then extracted for about two hours at 125° C. with a mixture of 90% ethylbenzene and 10% TiCl₄. This TiCl₄ treatment greatly enhances the performance of the catalyst.

At the conclusion of the extraction, the solid catalyst particles were dried by draining off residual TiCl₄and ethylbenzene, washing with heptane, and vacuum drying. The polymerization productivity of the catalyst was then tested using the general polymerization procedure described below.

### Polymerization Testing Procedure

A quantity of 4 ml of 25 wt % triethylaluminum (TEAl) was added to a leg of a two-leg stainless steel injector, along with 2 ml of a 0.1 molar solution of cyclohexylmethyl dimethoxysilane, as an external electron donor. The aluminum alkyl activates the catalyst by replacing one of the chlorides on the titanium with an alkyl group. Thereafter, alkylation can propagate continued insertion of propylene groups during a polymerization reaction. The external electron donor is important for controlling the nature of the propylene insertion, but it is not necessary for starting or maintaining propylene insertion.

20 Milligrams of a mixture containing 2 parts anhydrous MgCl₂ and 1 part of the experimental catalyst prepared above was added to another leg of the injector. The experimental catalyst was diluted in this manner to facilitate more accurate measurement of small quantities of catalyst tested in this example. The injector was then attached to the reactor so that the contents of the injector legs could be charged to the reactor under inert atmospheric conditions.

A polymerization reaction vessel comprising a 2-liter, stainless steel, jacketed pressure vessel, was purged of moisture and oxygen by heating to at least 100° C. while a slow bleed of dry nitrogen was maintained through the vessel. The TEAl and external electron donor were added to the reactor by flushing the appropriate injector leg with 600-800 ml of propylene. The catalyst was then added in a similar fashion by flushing the other leg of the injector with 200-400 ml of liquid propylene. 100 delta-psig (as measured across a 300 ml vessel) of hydrogen was added to the reactor. The vessel was sealed and heated to about 70° C. Once the temperature was at about 70° C., the polymerization reaction was allowed to continue for one hour. The polymerization reaction was then stopped by venting the residual propylene. The polymerization reaction vessel was opened and polymer was removed.

Catalyst productivity was measured by dividing the grams of polymer produced by the milligrams of active catalyst initially charged to the reactor.

The catalysts of the invention may be advantageously used in the polymerization of alk-1-enes. Suitable alk-1-enes include linear or branches C₂-C₁₀ alkenes, in particular linear C₂-C₁₀ alk-1-enes such as ethylene, propylene, but-1-ene, pent-1-ene, hex-1-ene, hept-1-ene, oct-1-ene non-1-ene, dec-1-ene or 4-methylpent-1-ene. Mixtures of these alk-1-enes may be polymerized as well.

The catalysts of the invention are, in particular, excellent catalytic systems for use in the production of propylene polymers, both homopolymers of propylene as well as copolymers of propylene and one or more further alk-1-enes having up to 10 carbon atoms.

The term copolymers as used herein also refers to copolymers wherein the further alk-1-ene having up to 10 carbon atoms is incorporated randomly. In these copolymers the comonomer content is generally less than about 15% by weight. The copolymers may also be in the form of so-called block or impact copolymers, which comprise at least a matrix of a propylene homopolymer or propylene random copolymer containing less than 15% by weight of a further alk-1-ene having up to 10 carbon atoms and a soft phase of a propylene copolymer containing about 15% to about 80% by weight of further alk-1-enes having up to 10 C-atoms. Also mixtures of comonomers are contemplated, resulting in, e.g., terpolymers of propylene.

The production of the propylene polymers may be carried out in any common reactor suitable for the polymerization of alk-1-enes, either batchwise or, preferably, continuously, i.e., in solution (bulk phase), as suspension polymerization or as gas phase polymerization. Examples of suitable reactors include continuously operated stirred reactors, loop reactors, fluid bed reactors, or horizontal or vertical stirred powder bed reactors. It will be understood that the polymerization may be carried out in a series of consecutively coupled reactors. The reaction time depends on the chosen reaction conditions. In general the reaction time is from about 0.2 hours to about 10 hours, usually from about 0.5 hours to 5.0 hours.

In general the polymerization is carried out at a temperature in the range of from about 20° C. to about 150° C., preferably from about 50° C. to about 120° C., and more preferably from about 60° C. to about 90° C., and a pressure in the range of from about 1 bar to about 100 bar, preferably from about 15 bar to about 40 bar, and more preferably from about 20 bar to 35 bar.

The molecular weight of the so produced polymers may be controlled and adjusted over a wide range by adding polymer chain transfer or termination inducing agents as commonly used in the art of polymerization, such as hydrogen. In addition an inert solvent, such as toluene or hexane, or an inert gas, such as nitrogen or argon, and smaller amounts of a powdered polymer, e.g., polypropylene powder, may be added.

The weight, i.e., (average molecular weights) of the propylene polymers produced by using the catalytic system of the invention, in general, are in the range of from about 10,000 g/mole to 1,000,000 g/mole and the melt flow rates are in the range of from about 0.1 to about 100 g/10 min, preferably from about 0.5 to about 50 g/10 min. The melt flow rate corresponds to the amount which is pressed within 10 minutes from a test instrument in accordance with ISO 1133 at a temperature of 230° C. and under a load of 2.06 kg. Certain applications might require different molecular weights than those mentioned above and are contemplated to be included among the polymers which are produced with the catalysts of the invention.

The catalytic systems of the invention enable the polymerization of alk-1-enes to produce polymers having a good morphology and a high bulk density when compared with the prior art catalytic systems. In addition, the catalytic systems of the invention have an increased productivity.

Due to their good mechanical properties the polymers obtainable by using the solid catalytic component of the present invention, and in particular the propylene homopolymers or the copolymers of propylene with one or more further alk-1-enes having up to 10 carbon atoms, can be used advantageously for the production of fibers or moldings, and especially for the production of films.

Ziegler-Natta catalysts are the subject of continued improvements, because their properties such as activity/productivity, morphology, and stereospecificity strongly effect the polymerization process.

While the invention has been described with reference to preferred embodiments, it will be understood by those skilled in the art that various changes may be made and equivalents may be substituted for elements thereof without departing from the scope of the invention.

Thus, it is intended that the invention not be limited to the particular embodiments disclosed herein, but that the invention will include all embodiments falling within the scope of the appended claims.

1. A method for making a magnesium-halide support of a specified particle shape, average diameter and particle diameter distribution, which comprises:
a) providing a non-aqueous solution of a magnesium-halide compound containing silica particles dispersed therein, said silica particles having an average particle diameter of less than 1.0 micron; and
b) crystallizing the magnesium-halide about the silica particles to provide the magnesium-halide support, wherein the magnesium-halide support has an approximately spherical shape, an average particle diameter from about 5 to about 150 microns, and a particle diameter distribution from about 1 to about 200.

2. The method for making a magnesium-halide support according to claim 1, wherein the magnesium-halide support has an average particle diameter from about 10 to about 100 microns, and a particle diameter distribution from about 5 to about 150.

3. The method for making a magnesium-halide support according to claim 2, wherein the magnesium-halide support has an average particle diameter from about 20 to about 80 microns, and a particle diameter distribution from about 10 to about 100.

4. The method for making a magnesium-halide support according to claim 1, wherein the silica particles have an approximately spherical shape, with a radius which does not vary by more than 20% from the center of the particle to any point on the particle surface.

5. The method for making a magnesium-halide support according to claim 4, wherein the silica particles are fumed silica.

6. The method for making a magnesium-halide support according to claim 5, wherein 50% of the silica particles have diameters of from about 0.05 to about 0.5 microns.

7. The method for making a magnesium-halide support according to claim 1, wherein the weight of the magnesium-halide is about 10 wt % to about 90 wt % of the magnesium-halide support.

8. The method for making a magnesium-halide support according to claim 7, wherein the weight of the magnesium-halide is about 20 wt % to about 80 wt % of the magnesium-halide support.

9. The method for making a magnesium-halide support according to claim 1, wherein the weight of the magnesium-halide is about 30 wt % to about 70 wt % of the magnesium-halide support.

10. The method for making a magnesium-halide support according to claim 1, wherein the crystallizing step comprises cooling the magnesium-halide solution from a temperature above the melting point of the magnesium halide compound to a temperature below the melting point of the magnesium halide compound.

11. The method for making a magnesium-halide support according to claim 1, wherein the non-aqueous solution of step (a) includes an anhydrous alcohol and the crystallizing step comprises removing the alcohol from the non-aqueous solution.

12. The method for making a magnesium-halide support according to claim 1, wherein the weight of the silica particle is less than about 10 wt % of the magnesium-halide support.

13. The method for making a magnesium-halide support according to claim 19, wherein the weight of the silica particle is less than about 5 wt % of the magnesium-halide support.

14. The method of making a magnesium-halide support according to claim 1, wherein the step (a) of providing a non-aqueous solution of a magnesium halide containing silica particles dispersed therein comprises:
dispersing the silica particles in a non-polar, non-ionic oil to form a silica-oil dispersion,
adding the magnesium halide compound to the silica-oil dispersion,
adding an anhydrous alkanol solvent to the silica-oil dispersion to provide a mixture containing dissolved magnesium-halide compound and silica-oil dispersion.

15. The method of making a magnesium-halide support according to claim 14 wherein the step of crystallizing the magnesium halide onto the silica particles comprises:
combining the mixture containing the dissolved magnesium-halide compound and silica-oil dispersion with a hydrocarbon solvent chilled to a predetermined temperature to cause the magnesium-halide compound to precipitate and crystallize onto the silica particles.

16. The method of making a magnesium-halide support according to claim 14 wherein the non-polar, non-ionic oil is selected from the group consisting of mineral oil, paraffin oil and silicone oil.

17. The method of making a magnesium-halide support according to claim 14, wherein the alkanol is selected from the group consisting of ethanol, methanol and 2-ethyl-1-hexanol.

18. The method of making a magnesium-halide support according to claim 14, wherein the magnesium-halide compound is selected from the group consisting of magnesium chloride, magnesium bromide, magnesium iodine, chloromagnesium hydroxide, bromomagnesium hydroxide and iodomagnesium hydroxide.

19. The method of making a magnesium-halide support according to claim 15, wherein the hydrocarbon solvent is selected from the group consisting of heptane, hexane and cyclohexane.

20. The method of making a magnesium-halide support according to claim 19 wherein the hydrocarbon solvent is chilled to a temperature ranging from about −90° C. to about 0° C.

21. A method for making a catalyst of a specified particle shape, average diameter and particle diameter distribution, which comprises:
a) providing a non-aqueous solution of a magnesium-halide containing silica particles dispersed therein, said silica particles having an average particle diameter of less than 1.0 micron;
b) crystallizing the magnesium-halide about the silica particles to provide a magnesium-halide support; and
c) treating the magnesium-halide support with a transition metal and an internal electron donor to form a catalyst, wherein the catalyst has an approximately spherical shape, an average particle diameter from about 2 to about 120 microns, and a particle diameter distribution from about 1 to about 200.

22. The method for making a catalyst according to claim 21, further comprising treating the catalyst with an aluminum co-catalyst.

23. The method for making a catalyst according to claim 21, further comprising treating the catalyst with an external electron donor.

24. The method for making a catalyst according to claim 21, further comprising treating the catalyst by extracting the catalyst with a transition metal.

25. The method for making a catalyst according to claim 21, further comprising treating the catalyst with an aluminum co-catalyst, an external electron donor and extracting the catalyst with a transition metal.

26. The method for making a catalyst according to claim 21 wherein the internal electron donor is selected from the groups consisting of diethyl phthalate, di-n-butyl phthalate, di-isobutyl phthalate, di-n-pentyl phthalate, di-n-hexyl phthalate, di-n-heptyl phthalate, di-n-octyl phthalate and di-2-ethylhexyl phthalate.

27. The method of claim 25 wherein the external election donor is selected from the group consisting of:
diisopropyldimethoxysilane, isobutylisopropyl-dimethoxysilane, diisobutyldimethoxysilane, dicyclopentyl-dimethoxysilane, cyclohexylmethyldimethoxysilane, dicyclohexyldimethoxysilane, isopropyl-tert-butyldimethoxysilane, isopropyl-sec-butyldimethoxysilane, and isobutyl-sec-butyldimethoxysilane.

28. A method for the polymerization of an olefin, comprising the steps of:
a) providing a catalyst, in accordance with a method including the steps of:
i) providing a non-aqueous solution of a magnesium-halide containing silica particles dispersed therein, said silica particles having an average particle diameter of less than 1.0 micron;
ii) crystallizing the magnesium-halide about the silica particles to provide a magnesium-halide support,
iii) treating the magnesium-halide support with a transition metal and an internal electron donor to form a catalyst,
iv) treating the catalyst with an aluminum co-catalyst and an external electron donor, wherein the resulting catalyst has an approximately spherical shape, an average particle diameter from about 2 to about 120 microns, and a particle diameter distribution from about 1 to about 200; and
b) contacting the olefin with the catalyst under polymerization reaction conditions.

29. A magnesium-halide support comprising: silica particles coated with a magnesium-halide, wherein the magnesium-halide support has an approximately spherical shape, an average particle diameter from about 2 to about 120 microns, and a particle diameter distribution from about 1 to about 200, said silica particles having an average particle diameter of less than 1.0 micron.

30. The magnesium-halide support according to claim 29, wherein the weight of the silica particles is less than about 10 wt % of the weight of the magnesium-halide support.

31. The magnesium-halide support according to claim 30, wherein the weight of the silica particles is less than about 5 wt % of the weight of the magnesium-halide support.

32. A catalyst comprising:
silica particles coated with magnesium-halide, an internal electron donor and a transition metal, wherein the catalyst has an approximately spherical shape, an average particle diameter from about 2 to about 120 microns, and a particle diameter distribution from about 1 to about 200, said silica particles having an average particle diameter of less than 1.0 micron.

33. The catalyst according to claim 32, wherein the weight of the silica particles is less than about 10 wt % of the weight of the catalyst.

34. The catalyst according to claim 33, wherein the weight of the silica particles is less than about 5 wt % of the weight of the catalyst.
